(19) United States
(12) Patent Application Publication
(10) Pub. No.: US 2006/0052241 A1
(43) Pub. Date: Mar. 9, 2006

(54) Mesostructural materials including nano-scale crystalline particles comprising a metal in solid solution within the crystalline structure thereof

(75) Inventors: Marc Airiau, Rueil-Malmaison (FR); Jean-Yves Chane-Ching, Eaubonne (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Rhodia Electronics and Catalysts, La Rochelle (FR)

(21) Appl. No.: 10/501,985

(22) PCT Filed: Jan. 20, 2003
(86) PCT No.: PCT/FR03/00167

§ 371 Date: Mar. 22, 2005

(30) Foreign Application Priority Data
Jan. 21, 2002 (FR) 02/00714

(51) Int. Cl. B01J 27/236

(52) U.S. Cl. 502/304; 428/402; 502/176

(57) ABSTRACT

The invention relates to a mesostructural material, preferably thermally stable, comprising a mineral phase within which nano-scale particles of a metallic oxide are dispersed, selected from a cerium, zirconium, titanium or rare earth metal oxide other than that of cerium. Said oxide comprises at least one metallic element M in a cationic form in a solid solution within the crystalline structure of said oxide. The invention further relates to a method for production of such a material, particularly in the form of heterogeneous catalysts or as a support for catalytic species.

The present invention relates to mesostructured or ordered mesoporous materials which are thermally stable and of particular use on their own as catalysts, for example as acidic, basic or redox catalysts, or as supports for catalytic species, in particular as supports for metallic catalytic species, in particular metallic noble metal type catalytic species.

Within the context of the present invention, a material termed “structured” is a material having an organized structure, i.e. within the context of the invention, a structure which has at least one diffusion peak in a diffusion diagram obtained when said structure is subjected to radiation diffusion (generally X rays or neutrons). Examples of obtaining such diffusion diagrams are described in “Small Angle X-ray Scattering” (Glatter and Kratky—Academic Press London—1982). The diffusion peak observed in the diffusion diagram obtained for a given structured material can be associated with a repeat distance which is characteristic of the material under consideration. This characteristic repeat distance will henceforth be designated by the term “spatial repeat period” of the structured system.

The term “mesostructured material” as used in the context of the present invention means a structured material having a spatial repeat period in the range 2 to 50 nm. The organized structure present in such a material will henceforth be termed the “mesostructure”.

Materials termed “ordered mesopores” constitute a particular case of mesostructured materials. They are mesoporous materials, i.e. solids having pores termed “mesopores” with a mean diameter in the range 2 to 50 nm, said mesopores having a characteristic organized spatial arrangement.

Usually, and in particular in the case of ordered mesoporous materials, the existence of a spatial repeat period means, for a mesostructured material, the existence of a repeat distance within the mesostructure in the range 2 to 50 nm, this distance generally being observable on photographs of the mesoporous material under the electron microscope.

The family of materials with the generic denomination “M41S” as described by Kresge et al in Nature, vol. 359, pp 710-712 (1992) or by Q Huo et al in Nature, vol 368, pp 317-321 (1994) constitutes the most widely known example of mesostructured and ordered mesoporous materials: they are silicas or aluminosilicates the structure of which is formed by two- or three-dimensional channels ordered in a hexagonal arrangement (MCM-41) or a cubic arrangement (MCM-48) or with a vesicular or lamellar structure (MCM-50). Although they are constituted by a structure having channels rather than mesopores, compounds termed MCM-41 and MCM-48 are often described in the literature as being ordered mesoporous materials. For example, Fengxi Chen et al describe, in Chemicals Materials, vol 9, No 12, p 2685 (1997), the channels present in said structures as “two- or three-dimensional mesopores”. In contrast, materials with a type MCM-50 vesicular or lamellar structure cannot be assimilated with mesoporous structures since their porous portions cannot be considered to be mesopores. Such structures will thus be solely designated by the term “mesostructures” in the remainder of the description.

Further examples of particular mesostructures that can be cited are materials termed “MSU” described, for example, by Bagshaw et al in Science (volume 269, pp 1242-1244 (1995)). Said mesostructures, termed “vermicular” structures, are schematically constituted by a three-dimensional network of channels with a substantially constant diameter.

Mesostructured and ordered mesoporous materials such as M41S or MSU are generally obtained by a process termed “liquid crystal templating”, usually designated by the initials “LCT”. This “LCT” process consists of forming a mineral matrix such as a silica gel or aluminosilicate gel in the presence of surfactant type amphiphilic compounds.

The term “liquid crystal templating” derives from the fact that schematically, the liquid crystal structure initially adopted by the molecules of surfactant dictates the final form of the mineral matrix.

Thus, it can be considered that within the liquid crystal structure, the mineral precursors locate themselves on the hydrophilic portions of amphiphilic compounds before condensing together, which endows the finally obtained mineral matrix with a spatial arrangement closely resembling that of the liquid crystal. On eliminating the surfactant, in particular by a heat treatment or by entraining in a solvent, a mesostructured or ordered mesoporous material is obtained, which constitutes a kind of imprint of the initial liquid crystal structure. In the Journal of the American Chemical Society (vol 114, p 10834; 1992), Beck et al explain the formation of the honeycomb structure of MCM-41 by initial organization of molecules of surfactant in the form of a hexagonal liquid crystal phase.

However, as shown by Davis et al in Microporous Materials vol 2, p 27 (1993), it appears that the mechanism employed is a little more complex, and in fact is initially constituted by the formation of composite species constituted by micelles covered with mineral precursors which in a second step organize themselves into a hexagonal, cubic or lamellar network. Nevertheless, the final arrangement of the mineral matrix obtained is strongly influenced by the initial form of the micelles formed by the amphiphilic molecules used, which justifies the denomination “LCT” and the fact that the term “template” is generally used to designate the surfactant type amphiphilic compounds used during the process.

In any event, regardless of their exact mode of production, mesostructured or ordered mesoporous materials are of very great interest, in particular in the field of catalysis, especially because of their large specific surface area and their particular ordered structure.

Further, it has recently been discovered that it is possible to synthesize mesostructured materials or ordered mesoporous materials using an analogous route to the conventional liquid crystal templating process, but with the additional presence of particles with nanometric dimensions in the template medium. This type of process described, in particular, in International patent application WO-A-01/32558, can produce mesostructures which integrate at least a portion of the particles with nanometric dimensions introduced into the template medium within their walls.

WO-A-01/32558 demonstrated that integrating particles with nanometric dimensions within the walls of the mesostructure endows a material with increased thermal stability compared with the generally low thermal stability of M41S type mesostructured materials. Further, selecting suitable starting nanometric particles renders it possible to substantially modulate the catalytic properties of the thermally stable materials obtained from a process such as that described in WO-A-01/32558.

Currently, however, only a relatively few types of particles with nanometric dimensions can be synthesized which have both a sufficiently small size and an appropriate surface chemistry for use in a process of the type described in WO-A-01/32558. For this reason, only a limited number of materials can currently be produced by incorporating particles with nanometric dimensions within the walls of a mesoporous structure to integrate specific particles, and thus the range of catalytic properties is relatively limited.

In particular, it is currently impossible to obtain thermally stable mesostructured materials by carrying out a templating type process of the type described in WO-A-01/32258 using crystalline particles based on oxide type “doped” materials, i.e. comprising a metallic element other than the metallic element forming the oxide in solid solution within the crystalline lattice of said oxide.

Even though it is known how to synthesize particles of metallic oxides with very small dimensions (in particular of the cerium oxide, titanium oxide, zirconia or rare earth oxide type, with dimensions of less than 10 nm), it is not known how to dope such particles by incorporating metallic elements in solid solution therein, nor how to directly synthesize doped oxides in the form of particles with sufficiently small dimensions and/or with a suitable surface for their use in a templating process of the type described in WO-A-01/32558, leading to the production of a thermally stable mesostructure.

Thus, using current techniques, it is impossible to produce thermally stable mesostructured materials integrating particles based on oxides comprising a “doping” metallic element in solid solution within the crystalline lattice within the walls of their mesostructure, which constitutes a problem since such doped oxides are known to have advantageous properties, in particular as regards the oxygen storage capacity and/or reagent adsorption capacity, in acid or basic catalysis, in redox catalysis, and/or as support materials for catalytic species of the metallic state noble metal type.

The inventors have now discovered that it is possible to synthesize such materials by first immobilizing particles of metal oxides within the walls of a mesostructure, then by introducing into the pores of said mesostructure, in a suitable concentration, a compound based on the metal to be introduced into the particles (this compound preferably being said metal in a cationic form, optionally complexed, or an alkoxide of said metal), and by subjecting the solid obtained to a heat treatment under controlled conditions.

Unexpectedly, the inventors have shown that integrating doping metallic cations in solid solution into particles immobilized within the walls of a mesostructure can be carried out at a relatively low temperature.

Further, the inventors' work has shown that, despite structural modifications induced during the process for integrating doping cations, in addition to catalytic properties due to the presence of particles comprising a metallic element in solid solution, the material that is finally obtained generally has both a high specific surface area and good thermal stability, which can in particular allow its use to be envisaged as a heterogeneous catalyst or as a support for catalytic species in heterogeneous catalysis.

Based on these discoveries, the present invention aims to provide mesostructured materials with a high specific surface area and good thermal stability associated with advantageous catalytic properties, in particular reagent adsorption properties, oxygen storage capacity, acido-basic catalysis and/or redox catalysis.

The invention also aims to provide mesostructured materials having a high specific surface area and good thermal stability suitable for use as a support for catalytic species, in particular of the metallic noble metal type.

More generally, the invention aims to provide heterogeneous mesoporous catalysts with a high specific surface area and high thermal stability.

In a first aspect, the present invention provides a mesostructured material (for example ordered mesoporous) comprising a mineral phase, within which are dispersed particles of nanometric dimensions, comprising at least one metal oxide in the crystalline state selected from a cerium oxide, a zirconium oxide, a titanium oxide and an oxide of a rare earth other than cerium, said oxide comprising at least one metallic element M in the cationic form, in solid solution within the crystalline lattice of said oxide.

The term “rare earth” means an element selected from yttrium and the lanthanides, the term “lanthanides” designating all elements with an atomic number in the range 57 (lanthanum) to 71 (lutetium) inclusive.

Preferably, the mesostructured material of the invention is thermally stable. Thus, the material of the invention generally retains a mesostructured character when it undergoes heat treatment at a temperature of 400° C. for a period of 6 hours. Preferably, the material of the invention retains said mesostructured character even when it is subjected for the same period to a temperature of 500° C., preferably a higher temperature, which can advantageously be up to 600° C., or even up to 700° C., and even in some particular cases up to 800° C., or more preferably, up to 900° C.

In general, when the material undergoes a heat treatment for 6 hours at said temperatures, in addition to retention of the mesostructured character, relatively good retention of the specific surface area is observed, meaning that following heat treatment, the BET specific surface area of said material does not generally vary by a factor of more than 50%, said factor preferably remaining 40% or less, and advantageously 30% or less. The variation factor in the BET specific surface area with which it is compared is calculated by the ratio (Si−Sf)/(Si) in which “Si” designates the BET specific surface area measured prior to heat treatment; and in which “Sf” designates the specific surface area BET measured after heat treatment, said BET specific surface areas being measured using the “Brunauer-Emmett-Teller” method described in The Journal of the American Chemical Society, vol. 60, page 309 (February 1938). Further, the pore distribution of the material, determined by the BET method, is usually observed to be substantially the same before and after a 6 hour heat treatment at said temperatures.

Regarding the thermal stability of the materials of the invention, it should be noted that exposure of mesostructured materials to high temperatures generally results in embrittlement of said materials, in particular because of the reduction in the thickness of the walls of their mesostructure, which results in collapse of said structure. The present invention surprisingly provides very temperature-stable compounds.

Advantageously, the mesostructured materials of the present invention are solids having, at least on a local level, one or more mesostructure(s) selected from:
mesoporous mesostructures with three-dimensional hexagonal P63/mmc symmetry, with two-dimensional hexagonal P6 mm symmetry, with three-dimensional cubic Ia3d, Im3m or Pn3m symmetry,
vesicular or lamellar type mesostructures; or
vermicular type mesostuctures.

Regarding the definition of these different symmetries and structures, reference should be made, for example, to articles in Chemical Materials, vol 9, No 12, pp 2685-2686 (1997), in Nature, vol 398, pp 223-226 (1999) or in Science, vol 269, pp 1242-1244 (1995).

The “particles with nanometric dimensions” present in the materials of the invention are preferably particles % with a spherical or isotropic morphology wherein at least 50% of the population has a mean diameter in the range 1 to 10 nm, advantageously less than 6 nm, with a granulometric distribution of said particles which is advantageously monodispersed.

More specifically, in a particular mode, the “particles with nanometric dimensions” present in the material of the invention can also designate anisotropic rod-like particles provided that at least 50% of the population of said particles have a mean transverse diameter in the range 1 to 10 nm and with a length that does not exceed 100 nm, with a granulometric distribution of said particles which is preferably monodispersed.

The particles of nanometric dimensions based on a metal oxide which are present in the material of the invention are at least partially crystalline particles within which the metal oxide generally has a degree of crystallinity which is preferably in the range 30% to 100% by volume. The volumic degree of crystallinity of a given metal oxide present in the particles with nanometric dimensions of the material of the invention can be calculated by the ratio of the area of a diffraction peak obtained by diffraction for a reference sample of said oxide in the completely crystalline state compared with the area of the same diffraction peak obtained for a sample of the material of the invention.

In addition to an ordered arrangement of their pore network, the presence of said partially crystalline particles in the mineral phase endows the mesostructured materials of the invention with an overall degree of crystallinity which is generally at least 10% by volume, and is preferably more than 30% by volume, said overall degree of crystallinity being calculated by multiplying the volumic degree of crystallinity experimentally determined for the particles using the method described above by the fraction of the volume of material which is occupied by said particles.

The term “degree of crystallinity of a mesostructured material” as used in the invention means the degree of crystallinity of the walls of the structure, which provides an overall measure of any crystallinity of the binding mineral phase and the crystallinity of the particles with nanometric dimensions included in said binding phase. In this respect, it should be noted that the crystallinity of a material within the context of the invention corresponds to a microscopic organization detectable by diffraction in particular (for example by large angle X ray diffraction) which should be particularly distinguished from the order presented by the mesostructure of the material on a more macroscopic level.

Characteristically, the particles with nanometric dimensions integrated into the binding mineral phase of the materials of the invention are particles based on a metal oxide which comprise at least one metal M in its cationic state, termed a “doping” element, which is present in solid solution, generally as an insertion and/or substitution solid solution, within the crystal structure of the oxide.

The term “cations present in solid solution within a metal oxide” means cations present as insertion and/or substitution cations within a crystalline metal oxide playing, in a characteristic manner, the role of a host crystalline lattice, said cations generally representing strictly less than 50 mole % of the total quantity of metal cations present in the oxide, meaning that the cations integrated into the solid solution are preferably in the minority compared with the constituent cations of the metal oxide into which they are integrated as a solid solution; the amount of said cations can reach 50% in certain cases, however. A crystalline oxide integrating cations in solid solution retains the structure of the pure crystalline oxide, although slight modifications to the lattice parameters can be observed, for example in agreement with Vegard's law. A crystalline oxide integrating cations in solid solution thus generally has an X ray diffraction diagram which is similar to that of the pure mixed oxide with a greater or lesser offset in the peaks.

Preferably, within the metal oxide of the particles included in the materials of the invention, the quantity of cations of the “doping” element M in solid solution (or all of the doping cations in solid solution (including M cations), when a plurality of doping cations are present) represent at least 0.2 mole % of the total quantity of metal cations present in the oxide, advantageously at least 0.5 mole %, and more advantageously at least 1 mole %. In general, it is usually preferable for the amount of “doping” cations (cations of element M, optionally in association with other doping cations), is as high as possible. When possible, in particular when considering the nature of the doping element(s) and the oxide into which they are introduced in solid solution, it is preferable for the amount of “doping” cations to be at least 5%, preferably at least 20%, and more advantageously at least 30% or even at least 40%.

The exact nature of the cations of metal M the presence of which can be envisaged depends on the nature of the metal oxide into which they are integrated in solid solution.

Thus, when the particles with nanometric dimensions integrated into the binding mineral phase of the materials of the invention are particles based on cerium oxide, element M present in the cationic state in solid solution can generally be selected from rare earths other than cerium, transition metals which are capable of being integrated in solid solution in the cationic form into a cerium oxide (in particular zirconium or manganese) or from alkaline-earth metals (in particular barium, calcium or strontium), said metal M preferably designating a rare earth other than cerium (advantageously lanthanum, yttrium, neodymium, praseodymium, dysprosium or europium) or zirconium. The quantity of cations of metal M which can be introduced in solid solution into a cerium oxide depends on the nature of said metal M. When the doping metal M represents zeolite or a rare earth other than cerium, the quantity of cations of metal M which can be integrated in solid solution can represent up to 50 mole % of the total quantity of metal cations present in the doped oxide.

In a further implementation, the particles with nanometric dimensions integrated into the binding mineral phase of the materials of the invention are particles based on zirconium oxide. In this case, the metal M present in the cationic state in solid solution can be selected from cerium, rare earths other than cerium, transition metals which can be integrated in the cationic form in solid solution into a zirconium oxide, or from alkaline-earth metals (in particular barium, calcium or strontium), said metal M preferably designating a rare earth (advantageously cerium, lanthanum, yttrium, neodymium, praseodymium, dysprosium or europium). When the doping metal M represents cerium or another rare earth, the quantity of cations of metal M which can be integrated in solid solution can represent up to 50 mole % of the total quantity of metallic cations present in the doped oxide.

When the particles with nanometric dimensions integrated into the mineral binder phase of the materials of the invention are particles based on titanium oxide, the metal M present in the cationic state in solid solution can be selected from rare earths, transition metals that can be integrated in the cationic form in solid solution within a titanium oxide or from alkaline-earth metals (in particular barium, calcium or strontium), said metal M preferably being an element forming a rutile or anatase type phase. Advantageously, in particles based on titanium oxide, the “doping” metal M is a rare earth or manganese, tin, vanadium, niobium, molybdenum or antimony.

Finally, when the particles with nanometric dimensions integrated into the mineral binder phase of he materials of the invention are particles based on a rare earth oxide, the metal M present in the cationic state in solid solution can be selected from rare earths other than the rare earth constituting said oxide, transition metals that can be integrated in the cationic form in solid solution within said rare earth oxide, or from alkaline-earth metals (in particular barium, calcium or strontium), said metal M then preferably being selected from cerium, zirconium, lanthanum, yttrium, neodymium, praseodymium, dysprosium and europium.

The mineral phase (or mineral matrix) of the mesostructured material of the present invention, which integrates the particles with nanometric dimensions defined above, constitutes an amorphous phase which is partially crystalline. Preferably, said mineral phase is at least partially constituted by silica.

When based on silica, the mineral phase can also comprise compounds based on the doping element M which is present in solid solution in the particles with nanometric dimensions.

In this context, the mineral phase can, for example, comprise metallic cations of metal M and/or clusters based on metal M dispersed, preferably homogeneously, within said mineral phase, for example in a matrix based on SiO₂. The term “cluster” based on metal M means a polyatomic entity with dimensions of less than 2 nm, preferably less than 1 nm, comprising at least some atoms of metal M, in oxidation state 0 or in a higher oxidation state (typically clusters based on oxide and/or hydroxide species of metal M, for example polyatomic entities within which several atoms of metal M are connected together by —O— or —OH— bridges, each of the atoms of metal M possibly being connected to one or more —OH groups).

The mineral phase of the materials of the invention can also comprise metal cations of element M and/or clusters based on metal M, on the surface of said mineral phase, for example on the surface of a matrix based on silica. This can in particular be the case when the metal M is zirconium, manganese, or a rare earth (in particular lanthanum, yttrium, neodymium, praseodymium, dysprosium or europium).

In an advantageous variation, the mineral phase of the materials of the invention comprises metal cations of element M and/or clusters based on metal M, both dispersed within said mineral phase and on the surface of said mineral phase. This variation can be particularly advantageous when metal M is zirconium, manganese, barium or a rare earth such as lanthanum, yttrium, neodymium, praseodymium, dysprosium or europium. Materials with this type of mineral phase often have increased thermal stability, generally associated with advantageous catalytic properties, in particular acido-basic and/or redox properties, which can, for example, render them suitable for the heterogeneous catalysis of oxidation reactions or for basic catalysis at relatively high temperatures, in particular hydrocarbon oxidation reactions (alkanes, aromatics . . . ).

The mineral phase present in the materials of the invention, also termed the mineral matrix, plays a characteristic role of binder between the particles with nanometric dimensions. In other words, the particles with nanometric dimensions present in the material are specifically located within this binder phase, i.e. within the walls of the mesoporous structure. Thus, it should be emphasized that the materials of the invention are particularly distinguished from mesoporous materials including particles in the inner space of their pores.

Usually, it is preferable for at least a portion of the particles integrated into the mineral binder phase to be in contact with the porous portions constituting the internal space of the material. In other words, the material of the invention is preferably a material in which the mineral phase effectively acts as an inter-particle binder, but does not completely enclose the particles with nanometric dimensions it contains.

It is important to consider the vital role of inter-particle consolidation played by the mineral phase. In fact, to encourage the formation of a structure in which the particles are partially exposed, in a first instance the temptation would be to substantially reduce the (binder mineral phase/particles) ratio. However, it appears that the stability of the structure is generally not guaranteed when the mineral matrix/particles mole ratio is beyond a proportion of 20:80.

For this reason, the mineral matrix/particles with nanometric dimensions ratio is advantageously in the range 20:80 to 99.5:0.5 in the materials of the invention, advantageously in the range 40:60 to 95:5. More preferably, this mole ratio is in the range 40:60 to 92:8.

In a particular variation, the materials of the invention can also comprise crystallites based on an oxide, hydroxide, oxy-hydroxide, carbonate or hydroxy-carbonate of the “doping” element M which is present in solid solution in particles with nanometric dimensions defined above. If necessary, said crystallites are included in the matrix and/or are present on its surface. Said crystallites are preferably based on zirconium oxide, manganese hydroxide and/or oxide, a hydroxide and/or oxide of a rare earth (in particular lanthanum oxide), or based on an oxide, carbonate or hydroxycarbonate of an alkaline-earth metal, in particular barium, strontium or calcium. When present, it is preferable for the size of the crystallites based on element M to be 700 nm or less, preferably 500 nm or less. Particularly advantageously, the size of said crystallites is in the range 2 nm to 200 nm.

In certain cases, clusters and/or crystallites based on metal M of the type potentially present in and/or on the surface of the mineral phase can also be present within or on the surface of the particles with nanometric dimensions which are dispersed within said phase. The presence of said clusters and/or crystallites can endow the material with enhanced catalytic properties.

According to the invention, the overall thickness of the walls of the mesoporous structure, which integrate the particles with nanometric dimensions and any crystallites and/or clusters based on metal M, is generally in the range 2 to 12 nm, usually in the range 3 to 10 nm.

Further, the materials of the invention also generally have a high BET specific surface area, usually in the range 750 to 2300 m² per cm³ of material. When expressed as surface area units per unit mass, this BET specific surface area is generally in the range 120 to 600 m²/g.

Usually, if a material of the invention undergoes a heat treatment for 6 hours at 800° C., its BET specific surface area remains at least 750 m² per cm³ of material, this BET specific surface area typically being in the range 800 to 1100 m² per cm³ of material (and usually in the range 120 to 300 m²). Preferably, following a heat treatment at 800° C. for 6 hours, the BET specific surface area of a material of the invention remains at least 900 m² per cm³.

Further, a material of the invention is advantageously such that, following heat treatment for 6 hours at 400° C., its BET specific surface area is at least 1500 m² per cm³ of material, said BET specific surface area typically being in the range 1600 and 2300 m² per cm³ of material (and more usually, in the range 250 to 600 m²/g), said specific surface area advantageously being at least 1800 m² per cm³ of material.

In the case of an ordered mesoporous structure, the pore diameter is generally at least 2 nm. Usually, this diameter is 8 nm or less, and more usually, it is 6 nm or less.

In a second aspect, the present invention also pertains to a process for preparing a mesostructured material integrating particles based on oxides comprising a metallic element M in solid solution as defined above. This process is characterized in that it comprises successive steps consisting in:
a) producing a mineral mesostructure integrating, within its walls, particles with nanometric dimensions comprising a metal oxide in its crystalline state selected from a cerium oxide, a zirconium oxide, a titanium oxide and a rare earth oxide other than cerium;
b) introducing into the mesoporous structure obtained, a compound based on said element M (preferably, said metal M is in its cationic form, optionally complexed, or an alkoxide of metal M), the total amount of element M introduced into the structure with respect to the total surface area developed by the mesostructure being less than 5 micromoles of cation per m² of surface; and
c) subjecting the mesostructure produced to a temperature of at least 300° C. and not higher than 1000° C.
   by means of which at least a portion of element M is integrated in the form of cations in solid solution within the oxide present in the particles with nanometric dimensions introduced during step a), which produces a material of the invention

Step a) of the process of the invention can be carried out using any means known to the skilled person. However, this step a) is preferably carried out by implementing the process of patent application WO-A-01/32558, i.e. by carrying out the steps consisting of:
a1) forming an initial medium, preferably aqueous or hydro-alcoholic, advantageously with a pH of less than 4, comprising a templating agent, namely a surfactant type amphiphilic compound, in particular a copolymer, preferably uncharged under the implementation conditions of the process, and which can form micelles in the reaction medium (in particular a non ionic block copolymer type surfactant, and more preferably a poly(ethylene oxide)-poly(propylene oxide)-poly (ethylene oxide) block terpolymer).
a2) adding to the medium of step a1) a colloidal dispersion of particles with nanometric dimensions based on a metal oxide in the crystalline state, selected from cerium oxide, a zirconium oxide, a titanium oxide and a rare earth oxide other than cerium, at least 50% of the population of colloidal particles preferably having a hydrodynamic diameter in the range 1 to 15 nm, and with a granulometric distribution of said colloidal particles that is preferably monodispersed
a3) adding a mineral precursor (generally of the alkaline silicate or silicon alkoxide type) to the medium to form a mesostructured mineral phase, usually at least partially, or even essentially constituted by silica, said mineral phase then integrating at least a portion of the particles with nanometric dimensions introduced during step a2), within the walls of said structure; and
a4) eliminating the templating agent, in particular by heat treatment or by entrainment by a solvent.
   these steps optionally being followed by one or more washing, drying, calcining and/or partial controlled chemical attack of the mineral phase step, for example using NH₄OH, NaOH or HF.

In any case, the mesoporous structure obtained after step a) preferably has a BET specific surface area of at least 1800 m² per cm³ of material, preferably at least 2100 m² per cm³ of material, and more advantageously of the order of 2400 m² per cm³ of material, i.e. in general, between 2200 and 2500 m² per cm³ of material. Further, said mesostructure produced during step a) preferably has a pore volume of at least 0.2 cm³/g for its pores with dimensions of 20 nm or less.

Regardless of the exact mode of implementing step a), the particles with nanometric dimensions based on a metal oxide which are immobilized within the mineral mesostructure are preferably particles of cerium oxide of the type described in patent applications FR-A-2 416 867, EP-A-0 206 906 or EP-A-0 208 580, particles of zirconium oxide such as those described in the Journal of Gel Science Technology, vol 1, p 223 (1994), nanometric particles of titanium oxide such as those described in the article in Chemical Materials, vol 10, pp 3217-3223 (1998), or particles of a rare earth oxide of the type described in European patent application EP-A-0 308 311.

More generally, the particles of metal oxides employed can also be obtained by acid treatment, washing or dispersion of ultrafine powders obtained, for example, by high temperature synthesis processes of known type in which metal chlorides are burned in a flame.

Step b) of the process consists of impregnating at least a portion of the porous zones of the mesostructure produced in step a) with a compound of element M which is to be introduced as a “doping agent” in solid solution within the oxide particles integrated into the walks of the mesostructure. Generally, said impregnation is carried out by introducing said cations of element M into the mesostructure by dispersing then within a vector phase, liquid or gaseous, said vector phase preferably being a liquid medium, in general an aqueous or hydroalcoholic medium or an organic solvent medium.

Step b) then usually consists of impregnating at least a portion of the porous zones of the mesostructure produced in step a) with a solution, generally aqueous, of a salt of a cation of metal M, preferably a nitrate, oxynitrate, oxalate and/or acetate of metal M, or with an aqueous or hydro-alcoholic solution comprising cations of metal M in the complexed state, or with a solution, generally in an anhydrous organic solvent, comprising an alkoxide of metal M. However, depending on the particular modes, it is also possible to envisage in step b) the use of dispersions of clusters based on metal M (in particular clusters based on oxides and/or hydroxides of metal M), or a gas phase comprising a compound of the metal (this gas phase preferably being constituted by said compound in the gas state).

In step b), the overall concentration of the cation of element M introduced into the porous zones has to be relatively small, in particular so that too great a reduction in the specific surface area of the material, or even blockage of the pores following the heat treatment of step c) is not observed. This overall concentration is such that the overall amount of cations of said element M with respect to the total developed specific surface area of the mesostructure generally remains less than 5 micromoles of cation per m² of surface area. Preferably, this amount remains at least 1 micromole of cation per m² of surface. The “total surface area of the mesostructured material” referred to here is calculated by multiplying the BET specific surface area, measured in m²/g for the mesostructured material obtained at the end of step a), by the mass of said material.

In general, during step b), the compounds based on metal M are preferably introduced into the mesostructure in the form of a solution, in an aqueous or hydro-alcoholic medium, or in an organic solvent. In this context, in order to produce said concentration conditions, the overall concentration C of cations M in the medium which is incorporated into the mesostructure from step b) is generally less than 2 mol/l and it is preferably in the range 0.1 mol/l to 1.5 mol/l, this concentration advantageously being 1 mol/l or less. It should be noted that, within the context of the present process, it is possible to carry out impregnation with relatively concentrated solutions, concentration C possibly being greater than 0.5 mol/l, or even greater than 0.7 mol/l in the majority of cases. In order to achieve incorporation of a solution having said concentration C in the mesostructured material from step a), step b) can be carried out in accordance with two possible routes.

In a first possible variation, step b) can be carried out by immersing the mesostructured material obtained at the end of step a) in a solution comprising element M in a concentration of the order of concentration C (generally in the range 0.1 to 1.5 mol/l, and advantageously in the range 0.2 to 1 mol/l), then filtering the medium obtained. The impregnated solid recovered following filtration then effectively comprises, in the porous zones, a solution comprising a compound of metal M, with the desired amount of metal M.

In a further possible variation, step b) can also be carried out by immersing the mesostructured material obtained at the end of step a) in a solution comprising the element M at a concentration close to concentration C (in general at a concentration that is advantageously in the range 0.2 to 1.5 mol/l, preferably in the range 0.4 to 1.2 mol/l), then centrifuging the medium obtained. Provided that the centrifugation is not carried out under conditions that are too severe (typically, centrifugation is carried out at 2000 to 5000 rpm for a period which generally does not exceed 30 minutes), the centrifugation residue obtained is an impregnated solid which comprises, within the porous zones, a solution comprising element M in the desired concentration.

Regardless of the exact mode by which step b) is carried out, the impregnated solid obtained at the end of this step then undergoes a heat treatment step c). This step c) is essentially intended to carry out at least partial integration of the cations of element M in solid solution within oxide based particles included in the walls of the mesostructure. To this end, it comprises a treatment of the material at a temperature of at least 300° C., said temperature preferably being at least 350° C., higher temperatures generally not being required for this integration of cations of element M into oxide based particles. In this regard, it should be emphasized that the process of the present invention can surprisingly integrate metallic doping cations in insertion or substitution solid solution into the metal oxide of particles with nanometric dimensions at low temperatures, which can produce functionalized mesostructured materials with very high specific surface areas.

However, in some cases, it may be advantageous to carry out the heat treatment of step c) at a temperature of at least 400° C. or even at least 500° C., in particular to improve certain physical and/or chemical characteristics of the material (concentrations of active catalytic sites, specific catalytic activities, . . . ), which generally does not excessively affect the specific surface area of the material. Nevertheless, in order not to call the stability of the mesostructure into question, the temperature of the heat treatment must not in general exceed 1000° C. and preferably remains below 950° C., advantageously 900° C. or less, and more preferably 850° C. or less.

Optionally, in particular in the case in which the metal M is introduced into step b) in the form of a solution, step c) can comprise a drying step, prior to the heat treatment. In this case, prior drying is generally carried out as slowly as possible, in particular to encourage ion exchange. To this end, drying is usually carried out at a temperature in the range 15° C. to 80° C., preferably at a temperature of less than 50° C., or even less than 40° C., and advantageously at ambient temperature. Drying can be carried out in an inert atmosphere (nitrogen, argon) or in an oxidizing atmosphere (air, oxygen) depending on the compounds present in the material. When the metal M is introduced into the material in the form of an alkoxide, drying is advantageously carried out in a water-free atmosphere.

Particularly advantageously, step c) can be carried out by subjecting the solid to a temperature gradient, from an initial temperature in the range 15° C. to 95° C. to a final temperature in the range 350° C. to 1000° C., advantageously with a temperature rise in the range 0.5° C. per minute to 2° C. per minute, and with one or more successive constant temperature stages at intermediate temperatures, preferably in the range 350° C. to 600° C., during varying periods, generally in the range 1 hour to 24 hours.

In a particularly advantageous implementation, following the impregnation/heat treatment procedures of steps b) and c), the process of the invention can comprise one or more subsequent impregnation/heat treatment cycles which involve steps of type b) and c) carried out on the solid obtained from the preceding cycle. Carrying out this type of successive multi-cycle impregnation/heat treatment cycles means that very good incorporation of element M in solid solution can be achieved in the particles of oxides integrated into the walls during step a). It is also possible to envisage carrying out several impregnation/heat treatment cycles using distinct type M doping elements by dint of which materials integrating particles of oxides doped with several metallic elements in solid solution can be obtained.

It should also be noted that the impregnation/heat treatment processes carried out can, along with integration of the element M in solid solution into the oxide particles, result in integration of said element in the cationic form or in the form of a cluster into and/or onto the surface of the mineral binder phase of the mesostructure, in particular when said binder phase is at least partially constituted by silica. Furthermore, at the end of a heat treatment step of type c), the formation of crystallites based on a compound of metal M, in particular of the oxide, hydroxide, oxyhydroxide, carbonate or hydroxycarbonate type, is observed to form on the surface of the binder phase, and/or at least partially integrated therein. The formation of said clusters or crystallites can also be observed on the surface and/or within the oxide particles.

Clearly, different results are obtained depending on the doping element M used. In the case in which an initial mesostructure integrating nanometric particles based on cerium oxide dispersed in a mineral phase based on silica is used, if the element M designates zirconium or manganese, the appearance of crystallites of oxides of metal M and/or integration of cations of metal M is observed on the silica surface, generally homogeneously. With other doping agents, cations may also be integrated into the silica matrix.

It should be emphasized that, surprisingly, despite the impregnation/heat treatment steps employed during the process of the invention, the solids obtained by carrying out steps of type a), b) and c) have a BET specific surface area which remains relatively high, and which generally represents at least 50%, advantageously at least 60%, and more preferably at least 65% of the BET specific surface area of the mesostructured material obtained from step a).

Because of their high specificity and their particular properties in terms of acido-basicity, optionally associated with oxidizing properties, the materials of the present invention may prove to be particularly useful as heterogeneous catalysts, in particular as heterogeneous acid, basic or redox catalysts.

Specifically, it should be emphasized that, of said catalysts, the materials of the invention based on particles of cerium oxide integrating zirconium in solid solution, or conversely, materials based on particles of zirconium oxide integrating cerium in solid solution, have been shown to be particularly advantageous in that they have high oxygen storage capacities. The materials of the invention based on particles of cerium oxide integrating zirconium in solid solution also in general have high thermal stability.

The mesostructured materials of the invention comprising particles of cerium oxide integrating manganese in solid solution within the walls of their mesostructures, which are moderate basic heterogeneous catalysts, have been shown to be particularly useful as absorption catalysts, in an oxidizing atmosphere, for oxides of nitrogen such as compounds termed NOₓ (NO, NO₂, N₂O in particular) which are present in certain gaseous effluents.

Furthermore, the materials of the invention, in particular materials based on particles of cerium oxide integrating cations of zirconium or a rare earth (other than cerium) in solid solution, may prove to be particularly useful as supports for catalytic species, in particular noble metal type metallic species (for example platinum).

These different uses constitute a further aspect of the present invention. Catalysts obtained by supporting catalytic species on a material of the invention constitute another aspect of the invention.

The characteristics and advantages of the present invention will become apparent from the following illustrative examples.

### EXAMPLE 1

### Preparation of a Mesostructured Material Integrating Nanometric Particles of Cerium Oxide Doped with Zirconium in Solid Solution, within a Silica Mineral Binder Matrix

1-1. Preparation of an Aqueous Colloidal Dispersion (D) of Cerium Oxide Particles

An aqueous dispersion of crystalline colloids of cerium oxide CeO₂, with a diameter centred on 5 an, was obtained by carrying out the following steps:
firstly, a precipitate of CeO₂ was prepared by thermohydrolysis of a partially neutralized ceric nitrate solution at 100° C. as described in EP-A-0 208 580;
then, 250 g of the thermohydrolyzed precipitate obtained containing 68.6% of CeO₂ was dispersed in 200 g of demineralized water and allowed to rest overnight at ambient temperature;
it was centrifuged at 4500 rpm for 15 minutes, then the supernatant phase was washed and concentrated by ultrafiltration on a 3 KD membrane.

The concentration of the colloidal dispersion obtained was 43% by weight, i.e. 4.15 M of CeO₂.

1-2. Preparation of a Mesostructured SiO₂/CeO₂ Compound

1) 2 g of Pluronics P123 (POE₍₂₀₎-PPO₍₇₀₎-POE₍₂₀₎ copolymer) from BASF and 58.1 g of demineralized water were added to a reactor at ambient temperature. 16.9 g of a 2 mole/litre HCl solution was then added. Stirring of the mixture was commenced using a magnetic stirrer. The medium obtained was kept at 37° C.
2) 4 g of the colloidal dispersion (D) prepared above was then added all at once, with stirring.
3) 2.08 g of TEOS (tetra-ethyl orthosilicate, MW=208 g) was then added at a constant rate over one hour using a pump (KDS syringe pump).
   The (SiO₂/CeO₂) mole ratio introduced was 50:50.
   The reaction ensemble was stirred at a temperature of 37° C. for 20 hours. The dispersion obtained was transferred into a closed vessel which was placed in an oven at 80° C. overnight.
   The solid product was recovered by centrifuging at 4500 rpm, then washed with a volume of demineralized water equivalent to the initial volume of the reaction ensemble.
   After separation by centrifuging, the solid product was dried at ambient temperature in air.
4) The product was then calcined at 500° C. for 6 hours. The temperature was ramped at 1° C./min.

The specific surface area measured by BET adsorption for the mesostructured compound obtained was 534 m²/g and the pore volume was 0.37 ml/g. The mesopore size was 4 nm.

An ordered texture was observed in the material by transmission electron microscopy of samples that had been microtomed.

In the mesoporous structure observed, the centre-to-centre distance of the pores was determined to be of the order of 14 nm, suggesting a wall thickness of the order of 10 nm.

At high resolution, perfectly crystalline particles of CeO₂ could be observed inserted into the walls of the mesoporous structure. Localized chemical analysis showed that the CeO₂ particles were dispersed perfectly in the SiO₂ walls.

1-3. Impregnation and Doping of Mesostructure Obtained

2 g of the mesostructured material obtained in step 1-2 was introduced into 50 ml of a zirconyl nitrate solution containing 0.25 mol/l of zirconium (NO₃/Zr mole ratio=1.3). The medium was stirred for one hour at 25° C.

The dispersion formed was then centrifuged at 4500 rpm for 15 minutes.

The centrifugation residue was recovered then dried by leaving it in air at 25° C. for 16 hours.

The solid obtained was then placed in an oven at 80° C. for 8 hours.

The solid was then slowly heated to 400° C., ramping the temperature at 1° C. per minute.

The solid was left at 400° C. for 6 hours then the temperature was allowed to fall slowly to 25° C.

The impregnation/heat treatment operation was repeated once more on the solid obtained (immersion in 50 ml of a zirconyl nitrate solution containing 0.25 mol/l of zirconium, stirring for one hour, centrifuging at 4500 rpm for 15 minutes, drying for 16 hours at 25° C., oven drying for 8 hours at 80° C., gradual heating (at 1° C./min) to 400° C., maintaining at 400° C. for 6 hours then slow temperature decrease).

X ray fluorescence analysis provided the following molar proportions for cations Ce, Si and Zr in the material obtained after these different steps:
(Si:Ce:Zr)=(45%:45%:10%).

BET analysis showed that the specific surface area of the product obtained was 275 m²/g, and the pore distribution observed was centred around 4 to 5 nm.

X ray diffraction revealed a spectrum that was very close to that of a pure cerium oxide, with peaks that were very slightly offset towards smaller distances, and the very faint presence of peaks that could be attributed to a quadratic ZrO₂ structure, indicating the presence of ZrO₂ crystallites.

### EXAMPLE 2

### Preparation of a Mesostructured Material Integrating Nanometric Particles of a Cerium Oxide Doped with Zirconium in Solid Solution within a Silica Mineral Binder Matrix

2 g of the mesostructured material obtained in step 1-2 of Example 1 was introduced into 50 ml of a zirconyl nitrate solution containing 1.5 mol/l of zirconium (NO₃/Zr mole ratio=1.3). The medium was stirred for one hour at 25° C.

The dispersion formed was then centrifuged at 4500 rpm for 15 minutes.

The centrifugation residue was recovered then dried by leaving it in air at 25° C. for 16 hours.

The solid obtained was then placed in an oven at 80° C. for 8 hours.

The solid was slowly heated to 400° C., ramping the temperature at 1° C. per minute. The solid was left at 400° C. for 6 hours, then the temperature was allowed to fall slowly to 25° C.

X ray fluorescence analysis provided the following molar proportions for cations Ce, Si and Zr in the material obtained after these different steps:
(Si:Ce:Zr)=(41%:41%:18%).

BET analysis showed that the specific surface area of the product obtained was 236 m²/g, and the pore distribution observed was centred around 4 to 5 nm.

X ray diffraction revealed a spectrum that was very close to that of a pure cerium oxide, with peaks that were very slightly offset towards larger distances (lattice parameter 5.39 angstroms), and the very faint presence of peaks that could be attributed to a quadratic ZrO₂ structure, indicating the presence of ZrO₂ crystallites.

Well-defined ZrO₂-rich domains of the order or 200 nm long were observed upon transmission electron microscopic analysis of a microtomed layer.

### EXAMPLE 3

### Preparation of a Mesostructured Material Integrating Nanometric Particles of a Cerium Oxide Doped with Lanthanum in Solid Solution within a Silica Mineral Binder Matrix

2 g of the mesostructured material obtained in step 1-2 of Example 1 was introduced into 50 ml of a lanthanum nitrate solution containing 0.25 mol/l of lanthanum. The medium was stirred for one hour at 25° C.

The dispersion formed was then centrifuged at 4500 rpm for 15 minutes.

The centrifugation residue was recovered then dried by leaving it in air at 25° C., for 16 hours.

The solid obtained was placed in an oven at 80° C. for 8 hours.

The solid was then slowly heated to 400° C., ramping the temperature at 1° C. per minute. The solid was left at 400° C. for 6 hours, then the temperature was allowed to fall slowly to 25° C.

The impregnation/heat treatment operation was repeated once more on the solid obtained (immersion in 50 ml of a lanthanum nitrate solution containing 0.25 mol/l of lanthanum, stirring for one hour, centrifuging at 4500 rpm for 15 minutes, drying for 16 hours at 25° C., oven drying for 8 hours at 80° C., gradual heating (at 1° C./min) to 400° C., maintaining at 400° C. for 6 hours then slow temperature decrease).

X ray fluorescence analysis provided the following molar proportions for cations Ce, Si and Zr in the material obtained after these different steps:
(Si:Ce:La)=(47%:47%:6%).

BET analysis showed that the specific surface area of the product obtained was 275 m²/g, and the pore distribution observed was centred around 4 to 5 nm.

X ray diffraction revealed a spectrum that was very close to that of a pure cerium oxide, with peaks that were very slightly offset to larger distances.

### EXAMPLE 4

### Preparation of a Mesostructured Material Integrating Nanometric Particles of Cerium Oxide Doped with Lanthanum in Solid Solution within a Silica Mineral Binder Matrix

2 g of the mesostructured material obtained in step 1-2 of Example 1 was introduced into 50 ml of a lanthanum nitrate solution containing 1.5 mol/l of lanthanum. The medium was stirred for one hour at 25° C.

The dispersion formed was then centrifuged at 4500 rpm for 15 minutes.

The centrifugation residue was recovered then dried by leaving it in air at 25° C. for 16 hours.

The solid obtained was placed in an oven at 80° C. for 8 hours.

The solid was slowly heated to 400° C., ramping the temperature at 1° C. per minute. The solid was left at 400° C. for 6 hours, then the temperature was allowed to fall slowly to 25° C.

X ray fluorescence analysis provided the following molar proportions for cations Ce, Si and Zr in the material obtained after these different steps:
(Si:Ce:La) (42%:42%:16%).

BET analysis showed that the specific surface area of the product obtained was 200 m²/g, and the pore distribution observed was centred around 4 to 5 nm.

X ray diffraction revealed a spectrum that was very close to that of a pure cerium oxide, with peaks that were very slightly offset towards larger distances (lattice parameter 5.43 angstroms).

Lanthanum-rich domains were observed under transmission electron microscopic analysis of a microtomed layer, along with crystallites based on lanthanum.

When the solid was analyzed using silicon NMR, the appearance of a peak at a chemical displacement of −80 ppm was observed, indicating the insertion of lanthanum into the silica matrix.

The solid was then calcined at 800° C. for 6 hours (gradual temperature rise (1° C. per minute) to 800° C., then maintained at 800° C. for 6 hours). X ray diffraction revealed a spectrum that was very close to that of a pure cerium oxide, with peaks that were very slightly offset towards larger distances (lattice parameter 5.45 angstroms), and characteristic peaks of a La₂O₃ phase, reflecting the formation of lanthanum oxide crystallites.

1. A mesostructured material comprising a mineral phase within which are dispersed particles of nanometric dimensions comprising at least one metal oxide in the crystalline state selected from a cerium oxide, a zirconium oxide, a titanium oxide and an oxide of a rare earth other than cerium, said oxide comprising at least one metallic element M in the cationic form, in solid solution within the crystalline lattice of said oxide.

2. A material according to claim 1, which is thermally stable.

3. A material according to claim 1, wherein at least at a local level, it has one or more mesostructures selected from mesoporous mesostructures with three-dimensional hexagonal P63/mmc symmetry, with two-dimensional hexagonal symmetry, with three-dimensional cubic Ia3d, Im3m or Pn3m symmetry; from vesicular or lamellar type mesostructures, or from vermicular type mesostructures.

4. A material according to claim 1, wherein said particles with nanometric dimensions are particles with a spherical or isotropic morphology at least 50% of the population of which has a mean diameter in the range 1 to 10 nm, or highly anisotropic rod type particles at least 50% of the population of which has a mean transverse diameter in the range 1 to 10 nm and a mean length that does not exceed 100 nm.

5. A material according to claim 1, wherein the metal oxide present within said particles with nanometric dimensions has a degree of crystallinity of 30% to 100% by volume.

6. A material according to claim 1, wherein the quantity of cations of element M in solid solution (or, if appropriate, of the totality of the solid solution doping agents) represents at least 0.2% of the total quantity of metallic cations present in the oxide.

7. A material according to claim 1, wherein said particles with nanometric dimensions are particles based on cerium oxide, and in that said element M is selected from rare earths other than cerium, transition metals that are capable of being integrated in the cationic form in solid solution into a cerium oxide, and alkaline-earth metals.

8. A material according to claim 1, wherein said particles with nanometric dimensions are particles based on zirconium oxide, and in that said element M is selected from rare earths, transition metals that are capable of being integrated in the cationic form in solid solution into a zirconium oxide, and alkaline-earth metals.

9. A material according to claim 1, wherein said particles with nanometric dimensions are particles based on titanium oxide, and said element M is selected from rare earths, transition metals that are capable of being integrated in the cationic form in solid solution into a titanium oxide, and alkaline-earth metals.

10. A material according to claim 1, wherein said particles with nanometric dimensions are particles based on an oxide of a rare earth other than cerium, and said element M is selected from rare earths other than the rare earth constituting said oxide, transition metals that are capable of being integrated in the cationic form in solid solution into a rare earth oxide, and alkaline-earth metals.

11. A material according to claim 1, wherein said mineral phase is at least partially constituted by silica.

12. A material according to claim 1, wherein the mineral phase also comprises metallic cations of metal M ad/or clusters based on metal M dispersed within said mineral phase and/or on the surface of said mineral phase.

13. A material according to claim 1, wherein at least a portion of the particles with nanometric dimensions dispersed within the mineral binder phase is in contact with porous portions constituting the internal space of the material.

14. A material according to claim 1, wherein the (mineral binder phase/particles with nanometric dimensions) molar ratio is in the range 20:80 to 99.5:0.5.

15. A material according to claim 1, which comprises crystallites based on the oxide, hydroxide, oxyhydroxide, carbonate or hydroxycarbonate of said element M.

16. An ordered mesoporous or mesostructured material according to claim 1, wherein said material has a BET specific surface area in the range 750 to 2300 m² per cm³ of material.

17. A process for preparing a material according to claim 1, which comprises successive steps comprising:
a) producing a mineral mesostructure integrating, within its walls, particles with nanometric dimensions comprising a metal oxide in its crystalline state selected from a cerium oxide, a zirconium oxide, a titanium oxide and a rare earth oxide other than cerium;
b) introducing into the mesoporous structure obtained, a compound based on said element M, the total amount of element M introduced into the structure with respect to the total surface area developed by the mesostructure being less than 5 micromoles of cation per m² of surface; and
c) subjecting the mesostructure produced to a temperature of at least 300° C. and not higher than 1000° C.

18. A preparation process according to claim 17, which step a) is implemented by carrying out the following steps:
a1) forming an initial medium comprising a templating agent, namely a surfactant type amphiphilic compound which can form micelles in the reaction medium;
a2) adding to the medium of step 1a) a colloidal dispersion of particles with nanometric dimensions based on a metal oxide in the crystalline state, selected from cerium oxide, a zirconium oxide, a titanium oxide and a rare earth oxide other than cerium;
a3) forming a mesostructured mineral phase, usually at least partially, or even essentially constituted by silica, said mineral phase by adding a mineral precursor to the medium; and
a4) eliminating the templating agent, in particular by heat treatment or by entrainment by a solvent.

19. A preparation process according to claim 17, wherien step b) is carried out by immersing the mesostructured material obtained at the end of step a) in a solution comprising the element M in a concentration in the range 0.1 to 1.5 mol/1 then filtering the medium obtained.

20. A preparation process according to claim 17, wherein step b) is carried out by immersing the mesostructured material obtained at the end of step a) in an aqueous or hydro-alcoholic solution comprising cations of metal M in a concentration in the range 0.2 to 1.5 mol/1 then centrifuging the medium obtained at a rate of 2000 to 5000 rpm, for a period not exceeding 30 minutes.

21. A preparation process according to claim 17, wherein, following the impregnation/heat treatment procedures of steps b) and c), it comprises one or more subsequent impregnation/heat treatment cycles implementing steps of type b) and c) carried out on the solid obtained from the preceding cycle.

22. A material that can be obtained by the process of claim 17, which is a heterogeneous acidic, basic or redox catalyst.

23. A material comprising particles of cerium oxide integrating manganese in solid solution within the walls of its mesostructure, as a catalyst for absorption of oxides of nitrogen.

24. A material obtained by a process according claim 1, as a support for catalytic species.

25. A catalyst obtained by supporting catalytic species on a material according to claim 1.
